(19) United States
(12) Patent Application Publication
(10) Pub. No.: US 2017/0024258 A1
(43) Pub. Date: Jan. 26, 2017

(54) SYSTEM FOR OPTIMIZING BATCH JOB DEPENDENCIES

(71) Applicant: HARTFORD FIRE INSURANCE COMPANY, Hartford, CT (US)

(72) Inventor: Lennox Douglas Reid, South Windsor, CT (US)

(21) Appl. No.: 14/804,934

(22) Filed: Jul. 21, 2015

(51) Int. Cl. G06F 9/50; G06F 9/52

(52) U.S. Cl. CPC G06F 9/5038; G06F 9/52

(57) ABSTRACT

A computer system for optimizing dependencies of batch jobs includes a scheduling server and a computer terminal. The scheduling server schedules an execution order of batch jobs on at least one batch server. The computer terminal receives a user input and queries the scheduling server for precedent batch jobs of a target batch job. The viewing application receives a query result from the scheduling server and depicts, on an electronic display, a dependency tree that includes one or more precedent batch jobs and the target batch job. The viewing application further depicts a critical path that includes critical precedent batch jobs that process data required by the target batch job. The viewing application provides for optimizations that optimize the execution order of the batch jobs such that the target batch job finishes executing earlier than the target batch job would have finished executing without the one or more optimizations.

### FIELD OF THE INVENTION

The present invention relates to the processing batch jobs.

### BACKGROUND OF THE INVENTION

Many individual investors, businesses and organizations rely on financial data sets to make sound investment decisions. Additionally, businesses and organizations require financial data captured at or after the close of the previous trading day to be compiled into financial data sets prior to the opening of the present trading day. Specifically, many people within a business or organization, such as accountants, traders and financial advisors, depend on receiving certain financial data sets by a certain time in order to perform their jobs. For example, a business or organization may have an employee who manages an investment fund and needs to formulate trading strategies prior to the opening of the trading day. In order to make optimum financial transactions, the employee needs to review, prior to the start of the present trading day, financial data sets detailing the status of one or more market conditions as they exist between the close of the previous trading day and the beginning of the present trading day. Thus, there is often a very short time period to collect relevant financial data and to compile the financial data sets relied upon by a business or organization.

Financial data sets may be in the form of financial reports, spread sheets, lists, and/or any data form appropriate for storing financial data. Financial data sets are often produced/compiled from financial data provided by third party vendors. It is imperative for many businesses or organizations to compile the third party financial data into the necessary financial data sets relied upon by a business or organization prior to the start of the present trading day.

Thus, many businesses and organizations use electronic computer applications to process large amount of timely financial data and to produce/compile financial data sets. A computer application that produces/compiles a financial data set may require financial data processed by multiple computer applications, and in turn, the multiple computer applications may require financial data processed by additional computer applications which may require financial data processed by yet further computer applications. Thus, a large number of interdependencies may exist among the various computer applications used to produce/compile a financial data set. The more interdependencies that exist among the various computer applications, the harder it becomes to track, manage and efficiently schedule the execution of the various computer applications (the “execution order”). Accordingly, a business or organization producing/compiling a financial data set by using various computer applications having a large number of interdependencies may miss opportunities to optimize/tune the execution order. Moreover, a business or organization producing/compiling a financial data set by using various computer applications having a large number of interdependencies may be unaware that a computer application will fail to process data necessary to produce/compile the financial data set within a time period sufficient to maintain the timeliness of the financial data set.

### SUMMARY OF THE INVENTION

In one embodiment, provided is a computer system for optimizing dependencies of batch jobs. The computer system includes a scheduling server and a computer terminal that communicates with the scheduling server. The scheduling server includes a scheduling processor and a scheduling memory device. The scheduling processor schedules an execution order of a plurality of batch jobs on at least one batch server. Each batch job of the plurality of batch jobs has an execution runtime. The computer terminal includes an electronic display, a terminal processor, and a terminal memory device. The terminal memory device stores a viewing application. The terminal processor executes the viewing application to receive a user input that identifies a target batch job of the plurality of batch jobs. The viewing application queries the scheduling server for precedent batch jobs of the target batch job. Precedent batch jobs are batch jobs of the plurality of batch jobs that process data subsequently processed by the target batch job. The viewing application receives a query result from the scheduling server. The query result includes the identified target batch job and one or more precedent batch jobs. The viewing application depicts, on the electronic display, a dependency tree that includes the target batch job and the one or more precedent batch jobs from the query result. The user input may further identify a time window that limits the received query result such that at least one of the target batch job and the one or more precedent batch jobs are included in the dependency tree based at least in part on the time window. The viewing application further depicts, on the electronic display, a critical path of the target batch job. The critical path includes one or more critical jobs that are a subset of the one or more precedent batch jobs that process data required by the target batch job. The viewing application may provide optimization tools that allow the user to make one or more optimizations to the execution order of the plurality of batch jobs. The one or more optimizations may optimize the execution order such that a total execution runtime of the one or more critical jobs is decreased such that the target batch job finishes executing earlier than the target batch job would have finished executing without the one or more optimizations. The total execution runtime is the sum of the execution runtimes of the one or more critical jobs. The viewing application may send instructions to the scheduling server to implement the one or more optimizations. The viewing application may further depict, on the electronic display, a status of at least one of the target batch job and the one or more precedent batch jobs. The status may be at least one of running, waiting, completed, completed and in critical path, failed, terminated, scheduled, and on hold. The viewing application may further depict, on the electronic display, at least one of a scheduled execution start time, an execution start time, the execution runtime, a historical execution start time, and a historical execution runtime for at least one of the target batch job and the one or more precedent batch jobs. The viewing application may generate, for at least one of the target batch job and the one or more precedent batch jobs, at least one of an expected execution start time and an expected execution runtime. At least one of the expected execution start time and the expected execution runtime are based at least in part on one of the scheduled execution start time, the execution start time, the execution runtime, the historical execution start time, and the historical execution runtime. The viewing application may further depict, on the electronic display, at least one of the generated expected execution start time and the expected execution runtime. The viewing application may generate a warning based at least in part on at least one of the scheduled execution start time, the execution start time, the execution runtime, the historical execution start time, the historical execution runtime, the expected execution start time, and the expected execution runtime. The viewing application may issue the warning to a user via at least one of the electronic display and an electronic mobile device. The viewing application may automatically make the one or more optimizations. The query result may further include an indication of dependencies among the target batch job and the one or more precedent batch jobs. The query result may further include an indication of a scheduled execution start time, an execution start time, and a status of each of the one or more precedent batch jobs and the target batch job. The status is at least one of running, waiting, completed, completed and in critical path, failed, terminated, scheduled, and on hold.

In another embodiment, provided is a computer terminal for optimizing dependencies of a target batch job. The computer terminal includes a terminal processor and a terminal memory device that stores a viewing application. The terminal processor executes the viewing application to receive a user input that identifies the target batch job of a plurality of batch jobs. Each batch job of the plurality of batch jobs has an execution runtime. The viewing application queries a scheduling server for precedent batch jobs of the target batch job. The scheduling server schedules an execution order of the plurality of batch jobs on one or more batch servers. Precedent batch jobs are batch jobs of the plurality of batch jobs that process data subsequently processed by the target batch job. The viewing application receives, from the scheduling server, a query result comprising the identified target batch job and one or more precedent batch jobs. The viewing application depicts, on an electronic display, a dependency tree that includes the target batch job and the one or more precedent batch jobs from the query result. At least one of the target batch job and the at least one precedent batch jobs are included in the dependency tree, depicted by the viewing application, based at least in part on a time window that limits the received query result and is derived from the user input. The viewing application further depicts, on the electronic display, a critical path that includes at least one critical job. The at least one critical job is a subset of the one or more precedent batch jobs that process data required by the target batch job. The viewing application may optimize, via one or more optimizations made by optimization tools provided by the viewing application, the execution order of the plurality of batch jobs. The one or more optimizations may optimize the execution order such that a total execution runtime of the at least one critical job is decreased such that the target batch job finishes executing earlier than the target batch job would have finished executing without the one or more optimizations. The total execution runtime is the sum of the execution runtimes of the at least one critical job. The viewing application sends instructions to the scheduling server to implement the one or more optimizations. At least one of the target batch job and the one or more precedent batch jobs may be depicted on the electronic display, by the viewing application, as having a status of at least one of: running, waiting, completed, completed and in critical path, failed, terminated, scheduled, and on hold. At least one of the target batch job and the one or more precedent batch jobs may be depicted on the electronic display, by the viewing application, as having at least one of a scheduled execution start time, the execution start time, an execution runtime, a historical execution start time, and a historical execution runtime. At least one of an expected execution start time of at least one of the target batch job and the one or more precedent batch jobs, and an expected execution runtime of at least one of the target batch job and the one or more precedent batch jobs, may depicted on the electronic display, by the viewing application, based at least in part on one of the scheduled execution start time, the execution start time, the execution runtime, the historical execution start time, and the historical execution runtime. The viewing application may issue a warning to a user based at least in part on at least one of the scheduled execution start time, the execution start time, the execution runtime, the historical execution start time, the historical execution runtime, the expected execution start time, and the expected execution runtime. The terminal processor may further execute the viewing application to automatically optimize the execution order of the plurality of batch jobs.

In still another embodiment, provided is a computerized method for optimizing dependencies of batch jobs. The computerized method includes receiving, by way of a viewing application stored in a terminal memory device of a computer terminal and executed by a terminal processor of the computer terminal, a user input that identifies a target batch job of a plurality of batch jobs, each batch job of the plurality of batch jobs having an execution runtime. The computerized method further includes querying, by way of the viewing application, a scheduling server for precedent batch jobs of the target batch job. The scheduling server schedules an execution order of the plurality of batch jobs on one or more batch servers. Precedent batch jobs are batch jobs of the plurality of batch jobs that process data subsequently processed by the target batch job. The computerized method further includes receiving, from the scheduling server by way of the viewing application, a query result that includes the identified target batch job and one or more precedent batch jobs. The computerized method further includes depicting, on the electronic display, by way of the viewing application and based at least in part on the received query result and a time window derived from the user input that limits the query result, a dependency tree that includes the target batch job and the one or more precedent batch jobs from the query result. The computerized method further includes depicting, by way of the viewing application and based at least in part on the received query result, a critical path of the target batch job on the electronic display. The critical path includes one or more critical jobs that are a subset of the one or more precedent batch jobs that process data required by the target batch job. The computerized method further includes optimizing, via one or more optimizations made by optimization tools provided by the viewing application, the execution order of the plurality of batch jobs. The one or more optimizations may optimize the execution order such that a total execution runtime of the one or more critical jobs is decreased such that the target batch job finishes executing earlier than the target batch job would have finished executing without the one or more optimizations. The total execution runtime is the sum of the execution runtimes of the one or more critical jobs. The computerized method further includes sending, by way of the viewing application, instructions to the scheduling server to implement the one or more optimizations. The computerized method may further include generating, by way of the viewing application, at least one of an expected execution start time and an expected execution runtime for at least one of the target batch job and the one or more precedent batch jobs. Optimizing the execution order may be based at least in part on one of the expected execution start time and the expected execution runtime. The computerized method may further include generating, by way of the viewing application, a warning based at least in part on at least one of a scheduled execution start time, an execution start time, the execution runtime, a historical execution start time, a historical execution runtime, the expected execution start time, and the expected execution runtime of at least one of the target batch job and the one or more precedent batch jobs. The computerized method may further include issuing the warning to a user via at least one of the electronic display and an electronic mobile device. The computerized method may further include the viewing application automatically optimizing the execution order. The query result may further include an indication of dependencies among the target batch job and the one or more precedent batch jobs. The query result may further include an indication of a scheduled execution start time, an execution start time, and a status of each of the one or more precedent batch jobs and the target batch job. The status may be at least one of running, waiting, completed, completed and in critical path, failed, terminated, scheduled, and on hold.

### BRIEF DESCRIPTION OF THE DRAWINGS

The foregoing summary, as well as the following detailed description of the exemplary embodiments, is better understood when read in conjunction with the appended drawings. For the purpose of illustrating the invention, there is shown in the drawings exemplary embodiments, it being understood, however, that the invention is not limited to the specific embodiments disclosed. In the drawings:

FIG. 1 is a block diagram of a financial computer system for depicting dependencies of financial batch jobs, according to an illustrative embodiment of the invention;

FIG. 2 is a block diagram of a computer terminal in the financial computer system of FIG. 1, according to an illustrative embodiment of the invention;

FIG. 3 is a graphical user interface (“GUI”) of a viewing application of the computer terminal of FIG. 2, according to an illustrative embodiment of the invention;

FIG. 4 is a flowchart depicting a process for depicting dependencies of financial batch jobs, according to an illustrative embodiment of the invention;

FIG. 5 is another GUI of the viewing application of FIG. 2, according to an illustrative embodiment of the invention;

FIG. 6 is another GUI of the viewing application of FIG. 2, according to an illustrative embodiment of the invention; and

FIG. 7 is another GUI of the viewing application of FIG. 2, according to an illustrative embodiment of the invention.

### DETAILED DESCRIPTION

As previously mentioned, many individual investors, businesses and organizations rely on financial data sets to make sound investment decisions. Accordingly, there is a demand for timely compiling financial data sets. Thus, many businesses and organizations use electronic computer applications to timely process large amounts of financial data and to produce/compile financial data sets. However, a large number of interdependencies may exist among the various computer applications. The more interdependencies that exist among the various computer applications, the harder tracking and managing the execution order of the computer applications becomes.

The present invention provides a financial computer system that simplifies the tracking, management and optimization of various interdependent computer applications (hereinafter “financial batch jobs”) that process large amounts of financial data used to compile time sensitive financial data sets. In particular, the computer system of the present invention analyzes and visually depicts interdependencies amongst various financial batch jobs used to produce/compile a financial data set.

Many types of interdependencies may exist between financial batch jobs. For example, a financial batch job may be implemented as a batch application requiring one or more input parameters that processes financial data. A financial batch job that processes financial data previously processed by another financial batch job is known as a dependent financial batch job. A financial batch job that processes financial data subsequently processed by a dependent financial batch job is known as a precedent financial batch job. Because a dependent financial batch job processes financial data previously processed by a precedent financial batch job, the dependent financial batch job is said to be dependent on the execution of the precedent financial batch job. Similarly, a precedent financial batch job, of which a dependent financial batch job is dependent on the execution of, is said to be precedent of the dependent financial batch job. A precedent financial batch job of a first dependent financial batch job may in turn be dependent on a second financial batch job. Accordingly, the second financial batch job is also a precedent financial batch job to the first dependent financial batch job. Thus, the first financial batch job is also said to be dependent on the second financial batch job.

A dependent financial batch job may or may not require the financial data processed by a precedent financial batch job in order to execute. A precedent financial batch job that processes financial data required by a dependent financial batch job to execute is said to be a critical job with respect to the dependent financial batch job. A precedent financial batch job that processes financial data not required by a dependent financial batch job to execute is said to be a non-critical job with respect to the dependent financial batch job. A dependent financial batch job may be dependent on the execution of more than one critical job. Likewise, a precedent financial batch job may be a critical job of more than one dependent financial batch job. A dependent financial batch job cannot execute until all of its critical jobs have executed. In other words, a dependent financial batch job cannot begin executing until all of is critical precedent financial batch jobs have first finished processing their own financial data. The set and/or subset of critical jobs for a dependent financial batch job is known as the critical path of the dependent financial batch job.

By visually depicting the interdependencies amongst various financial batch jobs used to produce/compile a financial data set, the financial computer system of the present application allows a user to quickly view and assess a dependency tree, including the critical path for a particular financial batch job known as a target financial batch job.

The financial computer system of the present invention further provides for historical data analysis and tuning/optimization of the execution order of the various financial batch jobs used to produce/compile financial data sets, such that financial batch jobs that produce/compile financial data sets relied upon by a business or organization for making financial decisions finish executing at the earliest possible time and/or in the most efficient manner. The financial computer system of the present invention may further provide for the issuance of warnings that notify a user of problematic conditions that exist within the execution order of the various financial batch jobs that may prevent certain financial data sets from being produced/compiled by certain applicable time deadlines. Thus, the computer system of the present application helps users make sure that financial data sets, which include financial data collected at or after the close of the previous trading day and relied upon by a business or organization to make financial decisions for the present trading day, are produced/compiled in time for the business or organization to review prior to the start of the present trading day.

The financial data sets relied upon by a business or organization for making financial decisions may relate to trading volumes, stock/bond prices and analytical market information (e.g., share/bond ratings), etc. The financial data sets may be in the form of financial reports, spreadsheets, lists, comma separated files, XML, proprietary data schemas, programming data structures/constructs and/or any data format appropriate for storing financial data. The produced/compiled financial data sets may present the processed financial data in the form of a .pdf, spreadsheet, Microsoft Report form, comma separated file and/or any other format suitable for viewing financial data. The produced/compiled financial data sets may be utilized by other computer systems. Financial data sets may be compiled from financial data provided by third party vendors. The provided third party vendor financial data may include raw data concerning investment vehicles (e.g., stocks, bonds, etc). The financial data may include trading information (e.g., trade volumes, buyer and seller information, etc), pricing information, and/or analytical data (e.g., company data, ratings, risk assessments, etc). Thus, the failure to compile or receive the financial data, required to compile a financial data set from a vendor in a timely manner may prevent the financial data set from being compiled prior to a requisite deadline.

While the computer systems and methods described herein specifically refer to financial batch jobs that compile financial data sets by processing financial data, it should be noted that these systems and methods are equally applicable to various types of batch jobs for processing various types of data. Thus, the batch jobs described herein may be any type of batch process executed on a computer system where interdependencies exist between multiple batch processes.

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. It is also to be understood that the terminology used is for the purpose of describing particular embodiments only, and is not intended to limit the scope of the claims of the present application.

In the drawings, like reference numerals refer to like features of the systems and methods of the present application. Accordingly, although certain descriptions may refer only to certain figures and reference numerals, it should be understood that such descriptions might be equally applicable to like references in other figures.

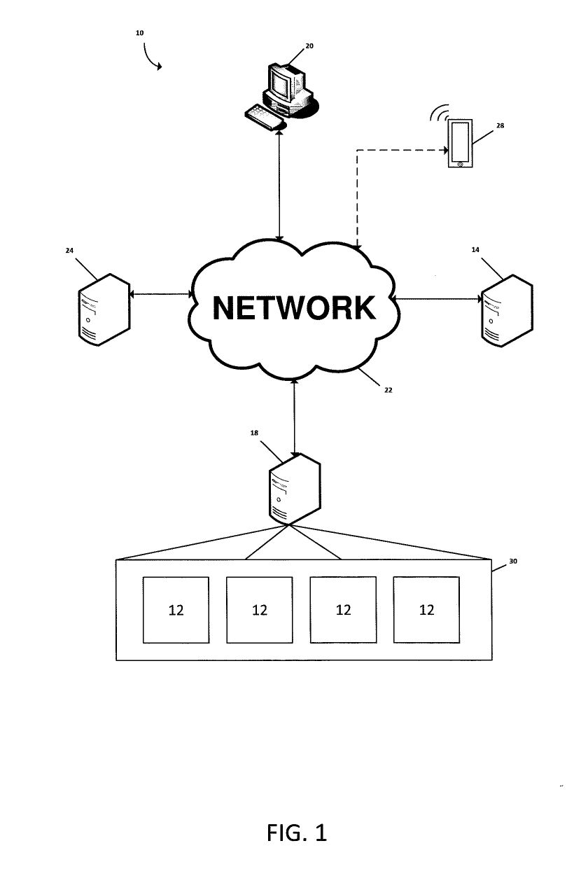

FIG. 1 is a block diagram of a financial computer system 10 for depicting dependencies of financial batch jobs 12, according to an illustrative embodiment of the invention. The financial computer system 10 includes a scheduling server 14, one or more batch servers 18 and a computer terminal 20. The scheduling server 14 communicates with the computer terminal 20 and the batch servers 18 via network 22. The financial computer system 10 may further include a historical database server 24 that communicates with the scheduling server 14, batch servers 18 and/or the computer terminal 20 via network 22. The computer terminal 20 may also communicate with one or more users 28 via network 22. The one or more users 28 may be connected to the network 22 via a wireless connection such as a cellular and/or 802.11 wireless network.

The scheduling server 14 includes at least one scheduling processor and scheduling memory device, and further includes schedules for the execution order of one or more financial batch jobs 12 on the batch servers 18. A financial batch job is a computer application that processes financial data, which may be defined by a name, scheduled execution start time, execution start time, execution runtime and status, and may also be dependent on one or more precedent financial batch jobs, which may additionally be critical jobs with respect to the financial batch job. The scheduling server 14 sets the execution order by determining when, and on which batch server 14, a particular financial batch job should begin executing, and then setting the scheduled execution start time of the financial batch job accordingly. The execution order, as set by the scheduling server 14, is based at least in part on the interdependencies and execution runtimes of the financial batch jobs 12. For example, a financial batch job should finish executing prior to its dependent financial batch jobs and typically cannot begin executing until all of its critical jobs (precedent financial batch jobs that process data required by the financial batch job) have finished executing. Thus, the scheduling server 14 schedules the execution order 30 such that each financial batch job 12, within the one or more financial batch jobs, executes on a batch server after all of its precedent financial batch jobs, of which some may be critical jobs, have finished executing, but before the scheduled execution time of its dependent financial batch jobs. The scheduling server 14 further sets the execution order such that financial batch jobs 12, used to produce a financial data set, collectively execute in the shortest amount of time reasonable to maintain a high level of accuracy with respect to the produced financial data set. The scheduling server 14 also responds to queries that request information regarding the execution order of the financial batch jobs 12.

The one or more batch servers 18 include at least one batch processor and at least one batch memory device. The financial batch jobs 12 execute on the batch servers 18 according to the execution order set by the scheduling server 14. The one or more batch servers 18 may be owned and/or operated by one or more businesses and/or organizations and may be located at one or more physical locations. The batch servers 18 may transmit, via network 22, execution data concerning the status of one or more financial batch jobs 12 to the scheduling server 14, the historical database server 24 and/or the computer terminal 20. For example, the batch servers 18 may notify the scheduling server 14 and/or the historical database server 24 that a particular financial batch job 12 has successfully finished executing.

The historical database server 24 may be agnostic with respect to the scheduling server 14 and/or the batch servers 18. In other words, the historical database server 24 may provide for a variety of common database communication protocols. The historical database server 24 may also periodically poll the scheduling server 14 and/or the batch servers 18 to query and receive information regarding the financial batch jobs 12 executing on the batch servers 18 and/or the execution order. For example the historical database server 24 may poll the scheduling server 14 and/or the batch servers 18 once every few seconds.

The financial batch jobs 12 may be implemented as batch applications. A batch application is a computer application that may require one or more input parameters and contains a sequential set of computer instructions. The set of computer instructions is typically intended to execute in a sequential order without requiring further interactive input by a human user. Many batch applications are configured to execute in a command shell application such as Windows Command Line, Bourne, BASH, C Shell, sh, ksh, and/or other similar command line environments. While the financial batch jobs 12 may be implemented as batch applications, it should be noted that the financial batch jobs 12 may be implemented as any type of computer application capable of processing financial data and/or producing a financial data set. A plurality of financial batch jobs 12 is a batch stream 30.

The network 22 may be a single network or a combination of one or more Local Area Networks (“LAN”), a Metropolitan Area Network (“MAN”), a Wide Area Network (“WAN”), a proprietary network, a Public Switched Telephone Network (“PSTN”), a Wireless Application Protocol (“WAP”) network, a BLUETOOTH®, a wireless LAN network, and/or an Internet Protocol (“IP”) network such as the Internet, an intranet, or an extranet. Note that any devices described herein may communicate via one or more such communication networks. In some embodiments, different networks are used to link different components of the financial computer system 10 together. The network 22 may be provided by a business or organization that operates the scheduling server 14, computer terminal 20 and/or batch servers 18. The network 22 may also be provided by a third party that does not operate the scheduling server 14, computer terminal 20 and/or batch servers 18.

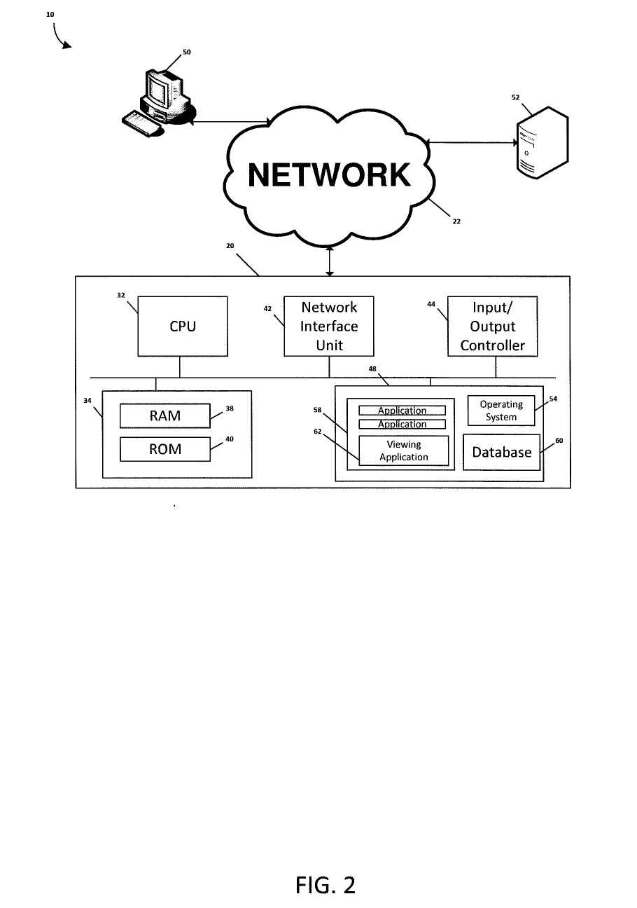

FIG. 2 is a block diagram of a computer terminal 20 in the financial computer system 10 of FIG. 1, according to an illustrative embodiment of the invention. The computer terminal 20 comprises at least one central processing unit (“CPU”) 32, system memory 34, which includes at least one random access memory (“RAM”) 38 and at least one read-only memory (“ROM”) 40, at least one network interface unit 42, an input/output controller 44, and one or more data storage devices 48. All of these later elements are in communication with the CPU 32 to facilitate the operation of the computer terminal 20. Suitable computer program code may be provided for executing numerous functions. For example, the computer program code may include program elements such as an operating system, a database management system and “device drivers” that allow the processor to interface with computer peripheral devices (e.g., a video display, a keyboard, a computer mouse, etc.) via the input-output controller 44.

The computer terminal 20 may be configured in many different ways. For example, the computer terminal 20 may be linked, via network 22 (also shown in FIG. 1), to another computer terminal 50 and/or one or more intermediary systems 52. The computer terminal 20 may be a conventional standalone computer or alternatively, the function of the computer terminal 20 may be distributed across multiple computing systems and architectures. In some embodiments, the computer terminal 20 may be configured in a distributed architecture, wherein databases and processors are housed in separate units or locations. Some such units perform primary processing functions and contain at a minimum, a general controller or a processor 32 and a system memory 34. In such embodiments, each of these units is attached via the network interface unit 42 to a communication hub or port (not shown) that serves as a primary communication link with other servers, client or user computers and other related devices. The communications hub or port may have minimal processing capability itself, serving primarily as a communications router. A variety of communications protocols may be part of the system, including but not limited to: Ethernet, SAP®, SAS®, ATP, BLUETOOTH®, GSM and TCP/IP.

The CPU 32 comprises a processor, such as one or more conventional microprocessors and one or more supplementary co-processors such as math co-processors. The CPU 32 is in communication with the network interface unit 42 and the input/output controller 44, through which the CPU 32 communicates with other devices such as other servers, to include the scheduling server and/or the historical database server (both shown in FIG. 1 as 14 and 24, respectively), user terminals and/or devices. The network interface unit 42 and/or the input/output controller 44 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 32 is also in communication with the data storage device 48. The data storage device 48 may comprise an appropriate combination of magnetic, optical and/or semiconductor memory, and may include, for example, RAM, ROM, flash drive, an optical disc such as a compact disc and/or a hard disk or drive. The CPU 32 and the data storage device 48 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the CPU 32 may be connected to the data storage device 48 via the network interface unit 42.

The data storage device 48 may store, for example, an operating system 54 for the computer terminal 20; one or more application(s) 58 (e.g., computer program code and/or a computer program product) adapted to direct the CPU 32 in accordance with the present invention, and particularly in accordance with the processes described in detail with regard to the CPU 32; and/or database(s) 60 adapted to store information that may be utilized to store information required by the program. Various applications 58 may be executed by the computer terminal 20—including a viewing application 62.

The operating system 54 and/or applications 58, including the viewing application 62, may be stored, for example, in a compressed, an uncompelled and/or an encrypted format, and may include computer program code. The instruction of the computer program code may be read into a main memory of the processor 32 from a computer-readable medium other than the data storage device 48, such as from the ROM 38 or from the RAM 40. While execution of sequences of instructions in the program causes the processor 32 to perform the process steps described herein, hard-wired circuitry may be used in place of, or in combination with, software instructions for implementation of the processes of the present invention. Thus, embodiments of the present invention are not limited to any specific combination of hardware and software.

An application may also be implemented in programmable hardware devices such as field programmable gate arrays, programmable array logic, programmable logic devices or the like. Applications may also be implemented in software for execution by various types of computer processors. An application of executable code may, for instance, comprise one or more physical or logical blocks of computer instructions, which may, for instance, be organized as an object, procedure, process or function. Nevertheless, the executable(s) of an identified application need not be physically located together, but may comprise separate instructions stored in different locations which, when joined logically together, comprise the application and achieve the stated purpose for the application such as implementing the procedural steps prescribed by the computer terminal 20. In the present invention, an application of executable code may be a compilation of many instructions, and may even be distributed over several different code partitions or segments, among different programs, and across several devices. Similarly, financial data, and/or data concerning financial batch jobs (shown as 12 in FIG. 1) may be identified and illustrated herein within applications, and may be embodied in any suitable form and organized within any suitable type of data structure. Such data may be collected as a single data set, or may be distributed over different locations including over different storage devices, and may exist, at least partially, merely as including signals on a system and/or network as shown and described herein.

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media may include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 32 (or any other processor of a device described herein) for execution. For example, the instructions may initially be written onto a magnetic disk of a remote computer (not shown). The remote computer can load the instructions into its dynamic memory and send the instructions over an Ethernet connection, cable line, or even telephone line using a modem. A communications device local to a computing device (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data that carry various types of information.

The viewing application 62 simplifies the tracking and management of the financial batch jobs (shown a 12 in FIG. 1) by depicting a financial batch job of interest to a user (known as the target financial batch job), and its precedent financial batch jobs, in a visual form that shows the interdependencies that exits amongst them. Specifically, the viewing application 62 allows a user to input information that can be used to query the scheduling server 14 and identify a target financial batch job and its precedent financial batch jobs within the execution order (shown as 30 in FIG. 1). The viewing application 62 then receives and parses the results of the scheduling server query and generates a dependency tree that has the target financial batch job as its root. The viewing application 62 further depicts the generated dependency tree in graphical form on an electronic display and may additionally identify the set and/or subset of all critical jobs (the critical path) of the target financial batch job. For example, the viewing application may show the critical path as a dashed-arrowed path and/or shading, coloring, bordering, highlighting, or otherwise distinguishing the critical financial batch jobs from non-critical financial batch jobs with respect to the target financial batch job.

The critical path may be calculated by the viewing application 62 in various ways. For example, the viewing application 62 may begin with a target financial batch job. The viewing application 62 then determines which critical precedent financial batch job of the target financial batch job will or has finished executing first. The viewing application 62 may calculate the expected time at which a critical precedent financial batch job will finish executing by adding the scheduled execution start time, or execution start time, of the critical precedent financial batch job, to the expected execution runtime of the critical precedent financial batch job. The viewing application 62 then designates the critical precedent financial batch job of the target financial batch job that has or will finish first as part of the critical path of the target job. The viewing application 62 then moves to the newly designated critical job and determines which critical precedent financial batch job of the newly designated critical job will or has finished executing first, and designates that critical precedent financial batch job as part of the critical path of the target financial batch job. The viewing application 62 repeats this process, moving from critical precedent financial batch job to critical precedent financial batch job, until a termination condition is met, such as reaching a root financial batch job or a precedent financial batch job that resides outside a specified time criteria.

The viewing application may also provide for the viewing of different areas of the dependency tree by “scrolling” and/or “zooming.” For example, the different areas of the dependency tree may be viewable by scrolling-left, scrolling-right, scrolling-up; and/or scrolling-down. Further, zooming-in and zooming-out may change the number of financial batch jobs, within the dependency tree, that are shown at one time on the electronic display.

The viewing application 62 may, for one or more financial batch jobs, show a scheduled execution start time, execution start time, execution runtime, a list of one or more precedent financial batch jobs and/or dependent financial batch jobs and a status. The status of the one or more financial batch jobs may be depicted by shading, coloring, bordering, highlighting, or otherwise distinguishing financial batch jobs of similar status from financial batch jobs having a different status. For example, financial batch jobs may be shown as having a status of: running as bright green; waiting as light tan; completed as tan; completed and in critical path as bright yellow; failed as red; terminated as orange; scheduled as light blue; and on hold as grey.

The viewing application 62 may show historical data, and/or predictive data derived from predictive analysis based on the historical data, within and/or near the dependency tree such that a user can quickly see problematic conditions. For example, the viewing application may request and receive historical data from the historical database server (shown as 24 in FIG. 1) regarding the target financial batch job, and its precedent financial batch jobs, which the viewing application uses to conduct predictive analysis of the target financial batch job and/or its precedent financial batch jobs. The historical data may include past scheduled execution start times, execution start times, execution runtimes and/or other data concerning the target financial batch job, and its precedent financial batch jobs. The historical data may also include data concerning financial batch jobs not included in the dependency tree, but which may still be relevant to financial batch jobs within the dependency tree. Accordingly, the viewing application may show that the target financial batch job will not execute by its scheduled execution time because one or more of its critical jobs is taking longer to execute than the expected execution runtime, which may be based on previous execution run times saved in the historical database.

The viewing application 62 may allow a user to only view the precedent financial batch jobs, of the target financial batch job, that fall within a time window specified by the user. For example, the user may input a start and an end time into the viewing application of 01:00 AM and 07:25 PM, respectively. Accordingly, the viewing application may show a target financial batch job and all of its precedent financial batch jobs that fall within the specified time window of 01:00 AM to 07:25 PM.

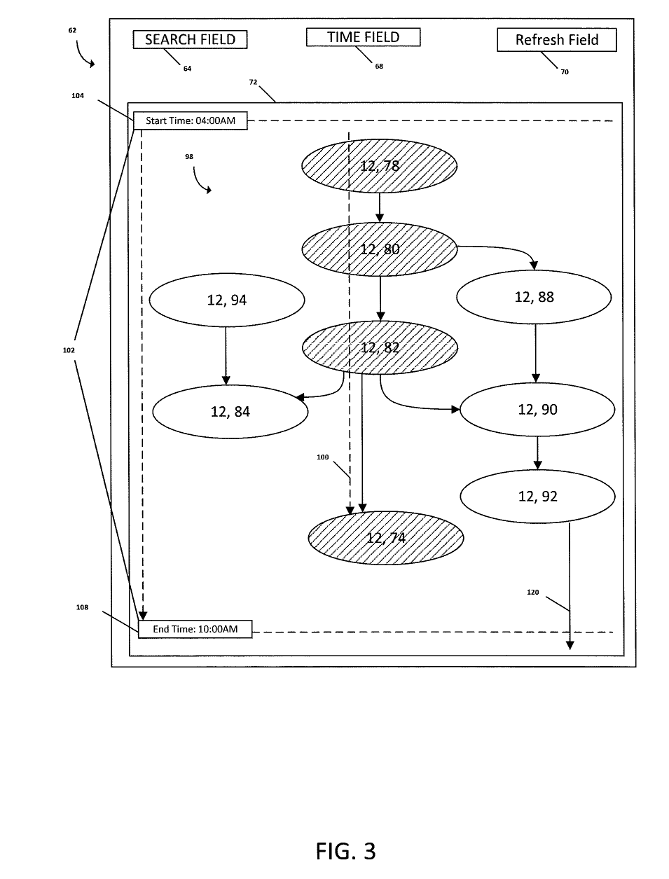

Referring now to FIG. 3, a graphical user interface (“GUI”) of the viewing application 62 of the computer terminal (shown as 20 in FIGS. 1 and 2) is shown, according to an illustrative embodiment of the invention. The viewing application 62 may be displayed on an electronic display such as a cathode ray tube (“CRT”) display, a liquid crystal display (“LCD”), an organic liquid crystal display (“OLED”), a plasma display or other technology capable of producing a visual image. The viewing application 62 has a search field 64, a time field 68, a refresh field 70 and a display area 72. The search 64 and time 68 fields receive search and time criteria, respectively, from a user that can be used to query the scheduling server (shown as 14 in FIG. 1) for data concerning the financial batch jobs 12 in the batch stream (shown as 30 in FIG. 1). The refresh field 70 receives refresh criteria from a user that can be used to indicate a refresh rate of the viewing application 62. The display area 72 includes visual depictions, produced from the results of querying the scheduling server (hereinafter also referred to as “scheduling server 14 query results”), of financial batch jobs 12 and their interdependencies. For example, the display area 72 may depict financial batch jobs 12 and their interdependencies as a dependency tree 98. A dependency tree 98 is a data structure and/or visual depiction of the subset of financial batch jobs 12, within a batch stream, returned by the scheduling server 14 query. While the financial batch jobs 74, 78, 80, 82, 84, 88, 90, 92, 94 and their interdependencies are shown in the display area 72 as a dependency tree 98, other relational shapes and/or structures may be used.

As previously stated, a financial batch job 12 may be implemented as a batch application requiring one or more input parameters that processes financial data. A financial batch job 12 that processes financial data previously processed by another financial batch job 12 is known as a dependent financial batch job. For example, financial batch job 82 is a dependent financial batch job because it processes financial data previously processed by financial batch job 80. A financial batch job 12 that processes financial data subsequently processed by a dependent financial batch job is known as a precedent financial batch job. Thus, financial batch job 80 is a precedent financial batch job because its processed financial data is subsequently processed by financial batch job 82. Because a dependent financial batch job processes financial data previously processed by a precedent financial batch job, the dependent financial batch job is said to be dependent on the execution of the precedent financial batch job. Similarly, a precedent financial batch job, of which a dependent financial batch job is dependent on the execution of, is said to be precedent of the dependent financial batch job. A precedent financial batch job of a first dependent financial batch job may in turn be dependent on a second financial batch job. Accordingly, the second financially batch job is also a precedent financial batch job to the first dependent financial batch job. Thus, the first financial batch job is also said to be dependent on the second financial batch job. For example, precedent financial batch job 80 of dependent batch job 82 is dependent on financial batch job 78. Accordingly, financial batch job 78 is also a precedent financial batch job of 82. Thus, financial batch job 82 is also dependent on financial batch job 78.

A dependent financial batch job may or may not require the financial data processed by a precedent financial batch job in order to execute. For example, as further shown in FIG. 3, dependent financial batch job 84 depends from precedent financial batch jobs 82 and 94. However, financial batch job 84 may only require the financial data processed by financial batch job 82 in order to begin executing. A precedent financial batch job that produces financial data required by a dependent financial batch job to execute is said to be a critical job with respect to the dependent financial batch job. Thus, financial batch job 82 is said to be a critical job with respect to financial batch job 84. A precedent financial batch job that processes financial data not required by a dependent financial batch job to execute is said to be a non-critical job with respect to the dependent financial batch job. Thus, financial batch job 94 is a non-critical job with respect to financial batch job 84. A dependent financial batch job may be dependent on the execution of more than one critical job. Likewise, a precedent financial batch job may be a critical job of more than one dependent financial batch job. A dependent financial batch job cannot execute until all of its critical jobs have executed. In other words, a dependent financial batch job cannot begin executing until all of is critical precedent financial batch jobs have first finished processing their own financial data. The set and/or subset of critical jobs for a dependent financial batch job is known as the critical path of the dependent financial job. For example, as further shown in FIG. 3, financial batch jobs 78, 80 and 82 may all be critical jobs of financial batch job 74. Thus, financial batch jobs 78, 80 and 82 form the critical path 100 of financial batch job 74.

Each financial batch job 12 may have a name, scheduled execution start time, execution start time, execution runtime, status and a list of one or more precedent financial batch jobs, which the viewing application 62 may display in the display area 72. The scheduled execution time is set by the scheduling server 14 and represents the time that a financial batch job 12 should begin executing on the batch servers 18. The scheduling server 14 may change the scheduled execution time prior to the actual time the financial batch job 12 actually executes. The execution start time is the actual time the financial batch job 12 begins executing on the batch servers 18. The status represents the current status of the financial batch job 12 and may be one of the following: running, which indicates that the financial batch job 12 is presently executing on a batch server 18; waiting, which indicates that the all the precedent financial batch jobs of the financial batch job 12 have finished executing and that the financial batch job 12 is now waiting to execute on a batch server 18; completed, which indicates that the financial batch job 12 has successfully finished executing on a batch server 18; completed and in critical path, which indicates that the financial batch job 12 has successfully finished executing and lies within the critical path of a dependent financial batch job; failed, which indicates that the financial batch job 12 has failed to successfully execute on the batch servers 18 due to an error; terminated, which indicates that the financial batch job 12 was instructed to stop executing, or to completely forgo executing, on a batch server 18 prior to a successfully finishing executing on a batch server 18; scheduled, which indicates that the financial batch job 12 has received a scheduled execution time from the scheduling server 14, but that one or more of precedent financial jobs need to finish executing; and on hold, which indicates that the financial batch job 12 is not to execute on a batch server 18 at the scheduled time unless further instructions dictate otherwise.

The display area 72 may further depict a target financial batch job 74 as the base/root of the dependency tree 98.

The display area 72 may further only depict financial batch jobs 12 that fall within a specified time window 102 based at least in part on the received time criteria. The time window 102 may have a beginning time 104 and an end time 108. For example, as shown in FIG. 3, the target financial batch job 74 and all of its precedent financial batch jobs 78, 80 and 82 fall within the specified time-window 102 of 04:00 AM to 10:00 AM.

The display area 72 may further depict the critical path 100 of the target financial batch job 74. The critical path 100 may be depicted by a dashed-arrowed path and/or shading, as shown in FIG. 3, and/or coloring, bordering, highlighting, or otherwise distinguishing the financial batch jobs 78, 80 and 82 that form the critical path 100 of the target financial batch job 74 from the financial batch jobs 84, 88, 90, 92 and 94 that do not form the critical path 100.

The display area 72 may further depict, for one or more financial batch jobs 12, a scheduled execution start time, execution start time, execution runtime, and a list of one or more precedent financial batch jobs and/or dependent financial batch jobs.

The display area 72 may further depict the statuses of one or more financial batch jobs 12. The status of a financial batch job 12 may be depicted by shading, coloring, bordering, highlighting, or otherwise distinguishing financial batch jobs of similar status from financial batch jobs having a different status. For example, the display area 72 may use the following status color coding: running—bright green; waiting—light tan; completed—tan; completed and in critical path—bright yellow; failed—red; terminated—orange; scheduled—light blue; and on hold—grey.

The display area 72 may further be “zoomable” and/or “scrollable.” By zooming-in and zooming-out, the viewing application 62 adjusts the display area 72 to display more or fewer financial batch jobs 12 within the dependency tree 98, respectively. By scrolling-left, scrolling-right, scrolling-up and/or scrolling-down, the viewing application 62 adjusts the display area 72 to display different areas of the dependency tree 98.

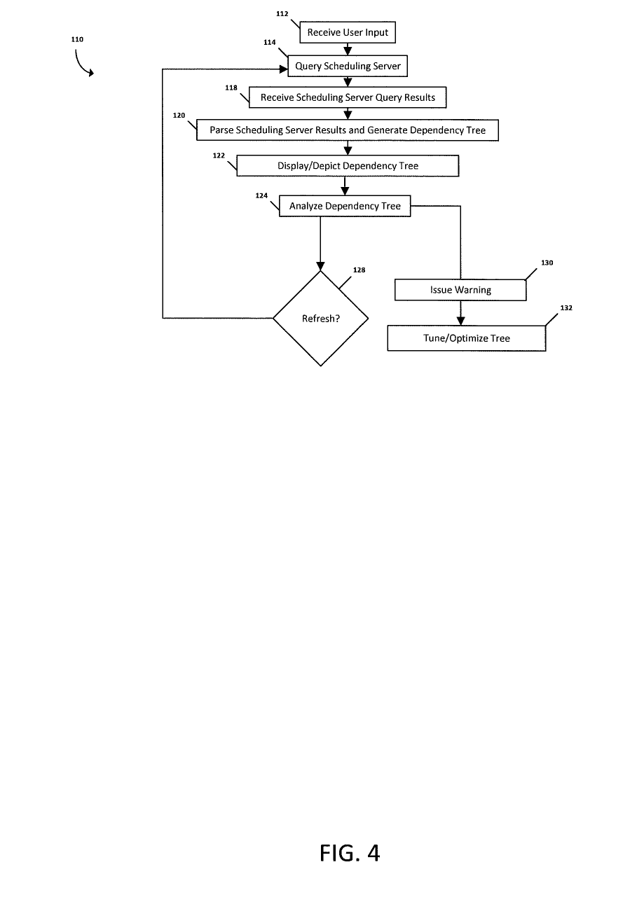

FIG. 4 is a flowchart depicting a process 110 for depicting dependencies of financial batch jobs 12 having steps 112, 114, 118, 120, 122, 124, 128, 130 and 132, according to an illustrative embodiment of the invention. The process 110 may be performed by, for example, the viewing application 62, described with reference to FIGS. 1 and 2. However, it should be understood that the methods described herein are exemplary embodiments of the present invention. Accordingly, in other embodiments, additional steps may be added and/or certain steps may be omitted, as desired. Furthermore, the flow chart(s) described herein do not imply a fixed order to the steps, and embodiments of the present invention may be practiced in any order that is practicable. However, any of the methods described herein may be performed by hardware, software, or any combination of these approaches. For example, a storage medium may store thereon instructions that when executed by a machine result in performance according to any of the embodiments described herein.

As shown in FIG. 4, at step 112, the viewing application 62 receives user input from a user, via the search field 64 and/or time-field 68, that identifies a target financial batch job of which the user wishes to view the corresponding precedent financial batch job dependency tree. The user input may also identify financial batch jobs of the plurality of financial batch jobs that are not precedent financial batch jobs of the target financial batch job, but are nonetheless of interest to the user. The viewing application 62 may also receive refresh criteria via the refresh field 70. The process 110 then proceeds to step 114.

At step 114, the viewing application 62 queries the scheduling server 14 for the user identified target financial batch job and all of its precedent financial batch jobs. For example, as shown in FIG. 3, a user may be interested in viewing the critical path 100 of target financial batch job 74 between the hours or 04:00 AM and 10:00 AM. Accordingly, the user may enter information sufficient to identify the target financial batch job 74 into the search field 64 and 04:00 AM to 10:00 AM in the time field 68. After the query has been sent to the scheduling server 14, the process 110 proceeds to step 118.

At step 118, the viewing application 62 receives the results of the scheduling server 14 query that requested the target financial batch job and all of its precedent financial batch jobs. The scheduling server 14 query results may come in the form of a list of records, wherein each record represents a financial batch job 12 that satisfies the terms of the query. The scheduling server 14 query results may contain records of financial batch jobs that are not precedent financial batch jobs of the target financial batch job, but are nonetheless of interest to the user. The scheduling server 14 query results may contain indications of the critical and non-critical dependencies, scheduled execution start times, execution start times, the status and/or other information concerning at least one financial batch job 12. The scheduling server 14 query results may be in the form of a string, xml file, comma-separated file and/or other type of appropriate data structure to include serialized custom classes. After receiving the scheduling server 14 query results, the process 110 proceeds to step 120.

At step 120, the viewing application 62 parses the results of the scheduling server 14 query and generates a dependency tree 98, wherein the structure of the dependency tree 98 is based at least in part on the scheduling server 14 query results. Parsing the scheduling server 14 query results entails identifying data within the scheduling server 14 query result that corresponds to financial batch jobs, and moving, copying and/or otherwise transforming that data into the dependency tree 98, such that the structure of the dependency tree 98 corresponds to the interdependencies that exists among the target financial batch job and its precedent financial batch jobs. The identified data for a financial batch job within the scheduling server 14 query result may include the name, scheduled execution start time, execution start time, execution runtime, status, and/or a list of the precedent and/or dependent financial batch jobs of the identified financial batch job. When the viewing application 62 identifies a financial batch job within the scheduling server 14 query results, it creates a data structure (typically referred to as a node, class object and/or leaf), that has data/property fields that correlate to the various financial batch job properties, discussed herein, such as the name, scheduled execution start time, execution start time, execution runtime, status, and/or a list of the precedent and/or dependent financial batch jobs. The identified data is then copied/transformed into the property fields of the created data structure and included in the dependency tree 98. For example, the dependency tree 98 shown in FIG. 3 has the following structure: the target financial batch job 74 forms the base/root of the dependency tree and is dependent on financial batch jobs 78, 80 and 82; financial batch job 82 is a critical job of the target financial batch job 74, as well as a precedent financial batch job of financial batch jobs 84, 90 and 92; financial batch job 82 is also dependent on precedent financial batch jobs 78 and 80; financial batch job 84 is dependent on precedent financial batch jobs 78, 80, 82 and 94; as no financial batch jobs 12 are shown as being dependent on financial batch job 84, financial batch job 84 is not a precedent financial batch job; financial batch job 92 depends on precedent financial batch jobs 78, 80, 82, 88 and 90; arrow 120 indicates that financial batch job 92 may be a precedent financial batch job to one or more financial batch jobs 12 (not shown) that exits within the batch stream 30 that have scheduled execution times, or execution start times, that fall outside the time-window 102 specified in the scheduling server 14 query; financial batch job 90 depends on precedent financial batch jobs 78, 80, 82 and 88; financial batch job 90 is also a precedent financial batch job to dependent financial batch job 92; financial batch job 94 has no precedent financial batch jobs, but is a precedent financial batch job to dependent financial batch job 84; financial batch job 88 is dependent on precedent financial batch jobs 78 and 80 and is also a precedent financial batch job of dependent financial batch jobs 90 and 92; financial batch job 80 is dependent on precedent financial batch job 78, is a critical job of the target financial batch job 74, and is also a precedent financial batch job of dependent financial batch jobs 82, 84, 88, 90 and 92; financial batch job 78 may or may not be dependent on one or more precedent financial batch jobs 12 (not shown) that exits within the batch stream 30 but that were not included in the scheduling server 14 query results as their scheduled execution time or execution runtime fell outside the time window 30 specified by the scheduling server 14 query; financial batch job 78 is also a precedent financial batch job to dependent financial batch jobs 80, 82, 84, 88, 90, 92 and the target financial batch job 74; financial batch jobs 78, 80 and 82 are shaded to indicate that they form the critical path 98 of the target financial batch job 74.

The viewing application may also query the historical database 24 for historical data concerning the financial batch jobs 12 that are included in the scheduling server 14 query results. The historical data may include past scheduled execution start times, execution start times, execution runtimes and/or other data concerning the financial batch jobs 12 included in the scheduling server 14 query results. The historical data may also include data concerning financial batch jobs 12 not included in the scheduling server 14 query results, but which may still be relevant to the financial batch jobs 12 included in the scheduling server 14 query results. After parsing the results of the scheduling server 14 query and generating the dependency tree 98, the process proceeds to step 122.

At step 122, the viewing application 62 displays the dependency tree 98 within the display area 72 of the viewing application 62 GUI. After displaying the dependency tree 98, the process proceeds to step 124.

At step 124, the viewing application 62 analyzes the dependency tree 98. Analyzing the dependency tree 98 may include: making predictive calculations such as expected execution runtimes and expected execution start times; evaluating the dependency tree for problematic conditions such as bottlenecks, lagging jobs, failed jobs and/or other potential problems. A lagging job is a financial batch job 12 that has a delayed execution start time. Bottlenecks occur when a small first set of precedent financial batch jobs depend on a larger set of precedent batch jobs, and one or more precedent financial batch job of the small first set of precedent financial batch jobs has an execution runtime that has or will exceed its historical and/or expected execution runtime. A bottleneck becomes more pronounced when one or more financial batch jobs of the first small set of financial batch jobs are lagging jobs and/or critical jobs.

The expected execution runtime of a financial batch job 12 may be generated based at least in part on the historical data retrieved from the historical database server 24 at step 118. For example execution runtime of a financial batch job 12 may be generated based at least in part on the past execution runtimes of the financial batch job 12. In such a case, the expected execution runtime of a financial batch job 12 may be the average of the past ten execution runtimes of the financial batch job 12.

The expected execution start time of a financial batch job 12 may be generated based at least in part on the scheduled execution start time, execution start time, historical execution start time and/or historical execution runtime of one or more financial batch jobs 12. For example, if financial batch jobs 78, 80 and 82 have statuses of completed and in critical path, running, and scheduled, respectively, then the expected execution start time of the target financial batch job 74 may be calculated by adding the expected execution runtime of precedent financial batch job 80, which may be based at least in part on the average of past execution runtimes of precedent financial batch job 80, to the execution start time of precedent financial batch job 80 to obtain an expected execution start time for precedent financial batch job 82. Adding the expected execution runtime of precedent financial batch job 82, which may be based at least in part on the average of past execution runtimes of precedent financial batch job 82, to the expected execution start time of precedent financial batch job 82 yields the expected execution start time of the target financial batch job 74.

Similarly, if precedent financial batch jobs 88 and 90 also have statuses of scheduled, then the expected start time of dependent financial batch job 92 can be calculated by first calculating the expected execution start times of precedent financial batch jobs 88 and 82 by adding the expected execution runtime of precedent financial batch job 80 to the execution start time of precedent financial batch job 80. Next, the expected execution start time of precedent financial batch job 90 can be calculated by taking the later time of the expected start time of precedent financial batch job 82 added to the expected runtime of precedent financial batch job 82, or, the expected execution start time of precedent financial batch job 88 added of the expected execution runtime of precedent financial batch job 88. Finally, the expected execution start time of dependent financial batch job 92 can be calculated by adding the expected execution start time of precedent financial batch job 90 to the expected execution runtime of financial batch job 90.

After analyzing the dependency tree 98, the process 110 may proceed to either step 128 and/or step 130.

At step 128, the viewing application 62 determines whether it should automatically refresh. If refresh criteria has been received, via the refresh field 70, then the process 110 proceeds to step 114 and queries the scheduling server 14 using the same search and time criteria received in step 112. The refresh criteria may indicate a time period and/or duration that indicate a refresh rate. The viewing application 62 cycles through steps 114, 118, 120, 122 and 124 based at least in part on the refresh rate. For example, the refresh criteria may indicate a refresh rate of ten minutes, thus, the viewing application 62 would execute steps 114, 118, 120, 122 and 124 once every ten minutes. The refresh criteria may also indicate a refresh rate of once every two and/or five minutes. The refresh criteria may also indicate that the refresh rate should be real time or near real time. When the refresh rate is real time or near real time, the viewing application 62 and display area 72 provide for real time or near real time monitoring of the financial batch jobs 12 within the batch stream 30.

At step 130, the viewing application 62 issues a warning regarding any problematic condition, such as bottlenecks, lagging jobs, failed jobs and/or other potential problems detected in step 124, to a user. The warning may be transmitted directly to a user via the electronic display and/or speakers that may be attached to the computer terminal 20. For example, the viewing application 62 may cause the speakers to produce a warning sound effect and generate a warning message within the graphical user interface. The viewing application 62 may also transmit a warning via e-mail, phone call, text message and/or by other electronic communication methods to a mobile device (shown as 28 in FIG. 1). After issuing a warning, the process 110 may proceed to step 132.

At step 132, the execution order is optimized, based at least in part on the depicted dependency tree 98 and the issuance, or lack thereof, of any warnings. Accordingly, the viewing application 62 may provide optimization tools for a user to implement the optimizations to the execution order. Such optimization tools may include the ability to add and/or delete the financial batch jobs 12 depicted in the display area 72 by clicking on them with a mouse. The optimization tools may also include the ability to move a financial batch job within the execution order by changing its precedent financial batch jobs, dependent financial batch jobs and/or scheduled execution start time. The optimization tools may further include drop down menus and/or additional input fields within the viewing application 62 GUI. The viewing application 62 may then transmit instructions, received from the user via the optimization tools, to the scheduling server 14 to implement the optimizations.

The viewing application 62 may also automatically optimize the execution order. For example, the viewing application 62 may automatically identify optimizations by applying optimization logic to the results of the predictive calculations made by the viewing application 62 in step 124. The viewing application 62 may then propose making an optimization to the user by sending the user a message requesting permission to implement the optimization. The message may be transmitted to the user in the same manner as the warning of step 130. The message may provide the user the option to accept or deny the proposed optimization. For example, the message may be a GUI dialogue box with an accept button and a deny button. The message could also be in the form of an e-mail and/or text message that instructs the user to reply with the word “accept” or “deny” in the body of the message. If the user accepts the proposed optimization, then the user application 62 will proceed to implement the proposed optimization by sending the appropriate instructions to the scheduling server 14. If the user denies the optimization, the user application 62 will not implement the proposed optimization without further instructions from the user. Alternatively, the viewing application 62 may automatically implement the optimization without first sending the user a request for permission to implement the optimization.

Optimizations may include changes to the execution order that alleviate the problems associated with one or more detected lagging jobs, bottlenecks, failed jobs and/or other potential problems. Optimizations may be based on the scheduled execution start time, execution start time, execution runtime, historical execution start time, historical execution runtime, expected execution start time and/or expected execution runtime of one or more financial batch jobs 12. For example, the viewing application 62 may determine that a dependent financial batch job will not begin executing by its scheduled execution time by adding the expected execution start time, or the actual execution start time, of a critical precedent financial batch job to the historical execution runtime of the critical financial batch job. Accordingly, unless the execution order is modified, the dependent financial batch job will not start at its scheduled execution start time. The viewing application may then determine that the expected execution runtime of the critical precedent financial batch job can be shortened by splitting the critical financial batch job into two separate financial batch jobs and executing them on separate batch servers. Accordingly, the viewing application 62 will either propose, and/or automatically execute, the optimization of splitting the critical financial batch job into two separate financial batch jobs.

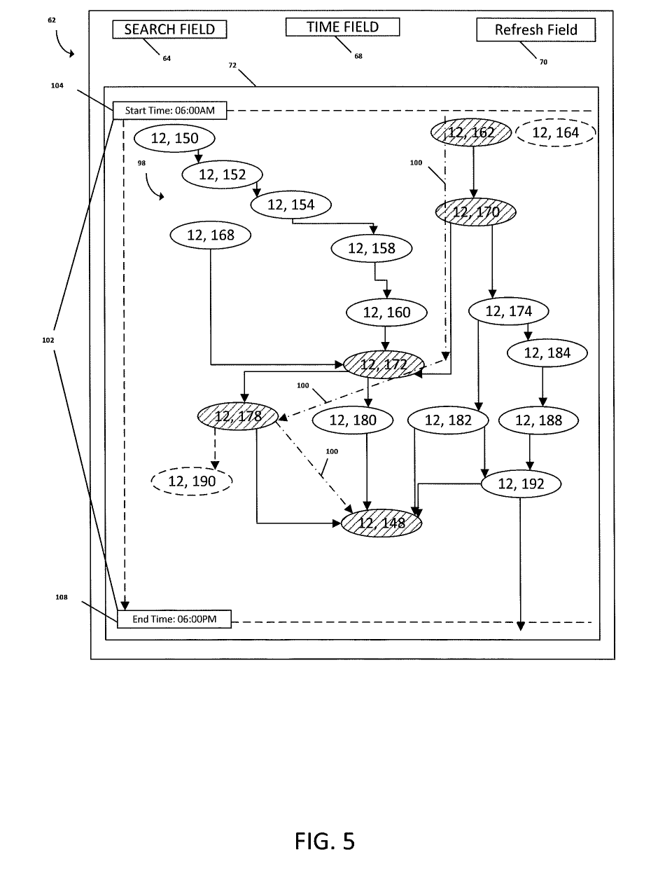

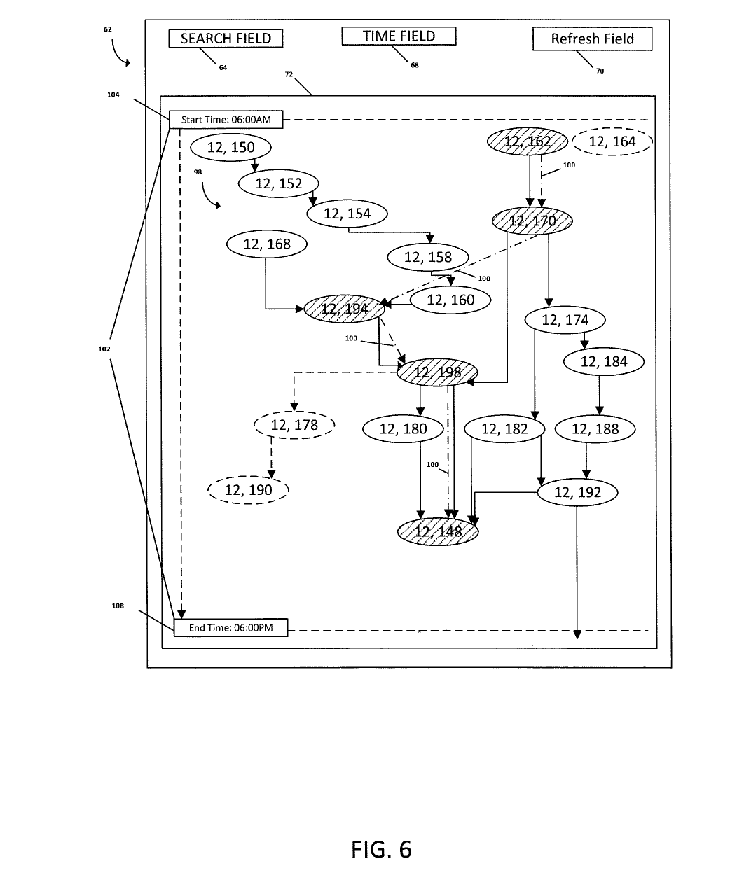

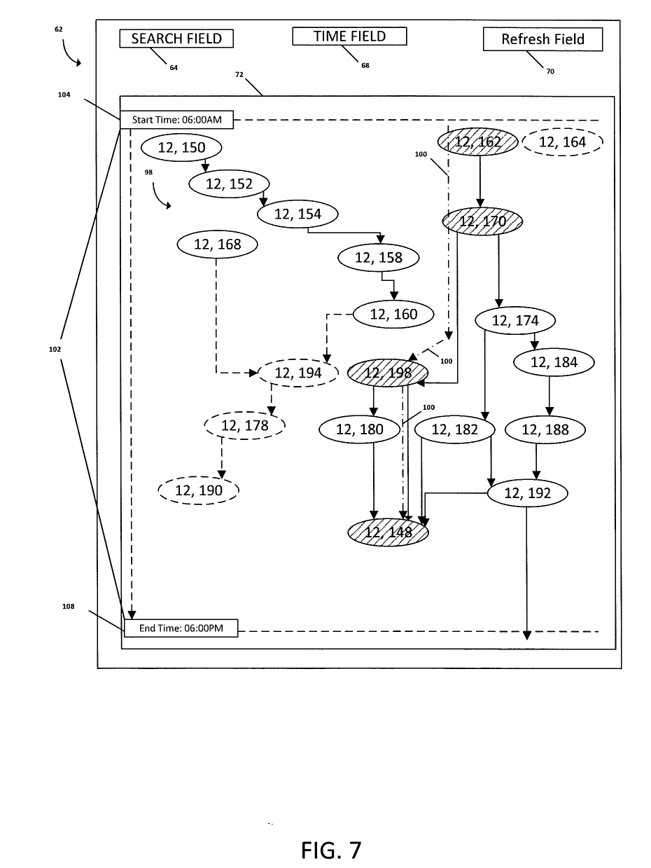

For example, FIG. 5 shows a dependency tree 98 generated by parsing the results of a scheduling server 14 query that requested target financial batch job 148 and all the financial batch jobs 12 that fall within a time window 102 of 06:00 AM to 06:00 PM. FIGS. 6 and 7 show optimized versions of the dependency tree 98 of FIG. 5. As shown in FIG. 5, the target financial batch job 148 depends on precedent financial batch jobs 150, 152, 154, 158, 160, 162, 168, 170, 172, 174, 178, 180, 182, 184, 188 and 192, and has a critical path 100 that includes financial batch jobs 162, 170, 172 and 178; dependent financial batch job 192 directly depends on precedent financial batch jobs 182 and 188; dependent financial batch job 190 directly depends on precedent financial batch job 178; dependent financial batch job 188 directly depends on precedent financial batch job 184; dependent financial batch job 182 depends directly on precedent financial batch job 174; dependent financial batch job 180 depends directly on precedent financial batch job 172; dependent financial batch job 178 depends directly on precedent financial batch job 172; dependent financial batch job 184 depends directly on precedent financial batch job 174; dependent financial batch job 172 depends directly on precedent financial batch jobs 160, 168 and 170; dependent financial batch job 174 depends directly on precedent financial batch job 170; precedent financial batch job 168 does not depend from any financial batch jobs 12; dependent financial batch job 160 depends directly on precedent financial batch job 158; dependent financial batch job 170 depends directly on precedent financial batch job 162; financial batch job 162 may or may not depend on one or more financial batch job 12 outside of the time-window 102; financial batch job 164 does not have any precedent financial batch jobs or any dependent financial batch jobs; dependent financial batch job 158 depends directly on precedent financial batch job 154; dependent financial batch job 154 depends directly on precedent financial batch job 152; dependent financial batch job 152 depends directly on precedent financial batch job 150; and precedent financial batch job 150 may or may not depend on one or more financial batch jobs 12 outside of the time-window 102. As financial batch jobs 164 and 190 are not precedent financial batch jobs with respect to the target financial batch job 148, the viewing application 62 may or may not depict them in the display area 72 as indicated by the dashed bordering around financial batch jobs 164 and 190 and the dashed arrow between financial batch jobs 178 and 190.

During step 130, the viewing application 62 may have issued a warning that financial batch job 172 is a bottleneck as it is a critical job of the target financial batch job 148 and directly depends on multiple precedent financial batch jobs, 160, 168 and 170. Further, the viewing application 62 may have calculated that financial batch job 172 has a long expected execution runtime. Further still, splitting financial batch job 172 into multiple financial batch jobs, shown as financial batch jobs 194 and 198 in FIGS. 6 and 7, may shorten the expected execution runtime of financial batch job 172. For example, as shown in FIG. 5, financial batch job 172 was to process/compile financial data that did not depend on the financial data processed/compiled by financial batch job 170. Thus, as shown in FIG. 6, the financial data that did not depend on the financial data processed/compiled by financial batch job 170 was split off into financial batch job 194, which can now begin executing prior to the completion of financial batch job 170. The remaining data of financial batch job 172 that did require the financial data processed by financial batch job 170 was split off into financial batch job 198. Both financial batch jobs 194 and 198 are critical jobs with respect to the target financial batch job 148, because previous financial batch job 172 (shown in FIG. 5) required financial data processed by financial batch jobs 160, 168 and 170. However, because financial batch job 194 can begin executing prior to the completion of the execution of financial batch job 170, the total expected execution runtime of financial batch jobs 194 and 198 is less than the expected execution runtime of financial batch job 172.

Additionally, during step 130, the viewing application 62 may have also issued a warning that critical job 178 has been terminated and therefore the target financial batch job 148 will not be able to start executing unless the execution order is modified. As shown in FIGS. 6 and 7, critical job 178 can be safely dropped from the critical path 100 of the target financial batch job 148, as shown by the dashed border of financial batch job 178 and the dashed arrows between financial batch jobs 198 and 178, and 194 and 178, respectively, such that the target financial batch job 148 no longer depends from financial batch job 178.

Additionally, as shown in FIG. 7, target financial batch job 148 may not require the financial data that was split off into financial batch job 194. Thus, financial batch job 194 may be excluded from the critical path altogether, as shown by the dashed border of financial batch jobs 194 and 178, and the dashed arrows between financial batch jobs 194 and 160, 194 and 168, 194 and 170, and 194 and 178.

Further still, the steps of 124, 130 and 132 may be utilized by the viewing application 62 to simulate optimizations proposed by a user and/or the viewing application 62 before actually modifying/altering the execution order. For example, the viewing application 62 may detect one or more bottlenecks, lagging jobs, failed jobs and/or other potential problems in step 124. The viewing application 62 may then generate one or more potential optimizations for the detected problems and run one or more simulations mixing and matching the potential optimizations. The viewing application may then propose, or automatically implement, one or more of the potential optimizations of the simulation having the earliest scheduled execution runtime and/or the shortest expected execution runtime of the target financial batch job 148.

The system and methods of the present application are particularly advantageous. For example, by visually depicting a target financial batch job (shown as 74 in FIG. 3 and as 148 in FIGS. 5, 6 and 7) and its precedent financial batch jobs, the financial computer system 10 allows inexperienced users to track, manage, and tune/optimize the execution order of financial batch jobs 12 of a batch stream 30 executing on batch servers 18.

Moreover, by readily identifying the critical path 100 of a target financial batch job (shown as 74 in FIG. 3 and as 148 in FIGS. 5, 6 and 7), the financial computer system 10 facilitates the direction of computing resources to be focused on optimizing/tuning the execution order of critical jobs within a critical path 100. By optimizing/tuning the execution order of critical jobs within a critical path 100, the efficiency of producing highly accurate financial data sets is increased.

Additionally, by issuing warnings concerning problematic conditions in the batch stream (shown as 30 in FIG. 1) such as bottlenecks, choke points, failed jobs and/or other potential problems, the financial computer system 10 can provide early notice of potential and/or actual problems. Accordingly, the early notice allows appropriate action to be taken well in advance of the problem manifesting and/or compounding in severity. Thus, the computer financial system 10 further increases the efficiency of generating a highly accurate financial data set.

Further, embodiments of the invention wherein the viewing application 62 automatically implements optimizations reduces the work load of users tracking and managing the execution of the financial batch jobs 12 on batch servers 18.

What is claimed is:

1. A computer system for optimizing dependencies of batch jobs comprising:
a scheduling server including a scheduling processor and a scheduling memory device, the scheduling processor scheduling an execution order of a plurality of batch jobs on at least one batch server, each batch job of the plurality of batch jobs having an execution runtime; and
a computer terminal in communication with the scheduling server and including an electronic display, a terminal processor, and a terminal memory device, the terminal memory device storing a viewing application, the terminal processor executes the viewing application to:
receive a user input that identifies a target batch job of the plurality of batch jobs;
query the scheduling server for precedent batch jobs of the target batch job, wherein precedent batch jobs are batch jobs of the plurality of batch jobs that process data subsequently processed by the target batch job;
receive a query result from the scheduling server, the query result comprising the identified target batch job and one or more precedent batch jobs; and
depict, on the electronic display, a dependency tree that includes the target batch job and the one or more precedent batch jobs from the query result;
wherein the user input further identifies a time window that limits the received query result such that at least one of the target batch job and the one or more precedent batch jobs are included in the dependency tree based at least in part on the time window;
wherein the viewing application further depicts, on the electronic display, a critical path of the target batch job, the critical path including one or more critical jobs, the one or more critical jobs being a subset of the one or more precedent batch jobs that process data required by the target batch job;
wherein the viewing application provides optimization tools that allow the user to make one or more optimizations to the execution order of the plurality of batch jobs such that a total execution runtime of the one or more critical jobs is decreased such that the target batch job finishes executing earlier than the target batch job would have finished executing without the one or more optimizations, the total execution runtime being the sum of the execution runtimes of the one or more critical jobs; and
wherein the viewing application sends instructions to the scheduling server to implement the one or more optimizations.

2. The computer system according to claim 1, wherein the viewing application further depicts, on the electronic display, a status of at least one of the target batch job and the one or more precedent batch jobs, wherein the status is at least one of running, waiting, completed, completed and in critical path, failed, terminated, scheduled, and on hold.

3. The computer system according to claim 1, wherein the viewing application further depicts, on the electronic display, at least one of a scheduled execution start time, an execution start time, the execution runtime, a historical execution start time, and a historical execution runtime for at least one of the target batch job and the one or more precedent batch jobs.

4. The computer system according to claim 3, wherein the viewing application:
generates, for at least one of the target batch job and the one or more precedent batch jobs, at least one of an expected execution start time and an expected execution runtime, wherein at least one of the expected execution start time and the expected execution runtime are based at least in part on one of the scheduled execution start time, the execution start time, the execution runtime, the historical execution start time, and the historical execution runtime; and
depicts, on the electronic display, at least one of the generated expected execution start time and the expected execution runtime.

5. The computer system according to claim 4, wherein the viewing application:
generates a warning based at least in part on at least one of the scheduled execution start time, the execution start time, the execution runtime, the historical execution start time, the historical execution runtime, the expected execution start time, and the expected execution runtime; and
issues the warning to a user via at least one of the electronic display and an electronic mobile device.

6. The computer system according to claim 1, wherein the viewing application automatically makes the one or more optimizations.

7. The computer system according to claim 1, wherein the query result further comprises an indication of dependencies among the target batch job and the one or more precedent batch jobs.

8. The computer system according to claim 1, wherein the query result further comprises an indication of a scheduled execution start time, an execution start time, and a status of each of the one or more precedent batch jobs and the target batch job,
wherein the status is at least one of running, waiting, completed, completed and in critical path, failed, terminated, scheduled, and on hold.

9. A computer terminal for optimizing dependencies of a target batch job comprising a terminal processor and a terminal memory device that stores a viewing application, the terminal processor executes the viewing application to:
receive a user input that identifies the target batch job of a plurality of batch jobs, each batch job of the plurality of batch jobs having an execution runtime;
query a scheduling server for precedent batch jobs of the target batch job, the scheduling server scheduling an execution order of the plurality of batch jobs on one or more batch servers, wherein precedent batch jobs are batch jobs of the plurality of batch jobs that process data subsequently processed by the target batch job;
receive, from the scheduling server, a query result comprising the identified target batch job and one or more precedent batch jobs; and
depict, on an electronic display, a dependency tree that includes the target batch job and the one or more precedent batch jobs from the query result;
wherein at least one of the target batch job and the at least one precedent batch jobs are included in the dependency tree, depicted by the viewing application, based at least in part on a time window that limits the received query result and is derived from the user input;
wherein the viewing application further depicts, on the electronic display, a critical path that includes at least one critical job, the at least one critical job being a subset of the one or more precedent batch jobs that process data required by the target batch job;
optimize, via one or more optimizations made by optimization tools provided by the viewing application, the execution order of the plurality of batch jobs such that a total execution runtime of the at least one critical job is decreased such that the target batch job finishes executing earlier than the target batch job would have finished executing without the one or more optimizations, the total execution runtime being the sum of the execution runtimes of the at least one critical job; and
send instructions to the scheduling server to implement the one or more optimizations.

10. The computer terminal according to claim 9, wherein at least one of the target batch job and the one or more precedent batch jobs are depicted on the electronic display, by the viewing application, as having a status of at least one of: running, waiting, completed, completed and in critical path, failed, terminated, scheduled, and on hold.

11. The computer terminal according to claim 9, wherein at least one of the target batch job and the one or more precedent batch jobs are depicted on the electronic display, by the viewing application, as having at least one of a scheduled execution start time, the execution start time, an execution runtime, a historical execution start time, and a historical execution runtime.

12. The computer terminal according to claim 11, wherein at least one of an expected execution start time of at least one of the target batch job and the one or more precedent batch jobs, and an expected execution runtime of at least one of the target batch job and the one or more precedent batch jobs, are depicted on the electronic display, by the viewing application, based at least in part on one of the scheduled execution start time, the execution start time, the execution runtime, the historical execution start time, and the historical execution runtime.

13. The computer terminal according to claim 12, wherein the viewing application issues a warning to a user based at least in part on at least one of the scheduled execution start time, the execution start time, the execution runtime, the historical execution start time, the historical execution runtime, the expected execution start time, and the expected execution runtime.

14. The computer terminal according to claim 9, wherein the terminal processor further executes the viewing application to automatically optimize the execution order of the plurality of batch jobs.

15. A computerized method for optimizing dependencies of batch jobs comprising:
receiving, by way of a viewing application stored in a terminal memory device of a computer terminal and executed by a terminal processor of the computer terminal, a user input that identifies a target batch job of a plurality of batch jobs, each batch job of the plurality of batch jobs having an execution runtime;
querying, by way of the viewing application, a scheduling server for precedent batch jobs of the target batch job, the scheduling server scheduling an execution order of the plurality of batch jobs on one or more batch servers, wherein precedent batch jobs are batch jobs of the plurality of batch jobs that process data subsequently processed by the target batch job;
receiving, from the scheduling server by way of the viewing application, a query result comprising the identified target batch job and one or more precedent batch jobs;
depicting, on the electronic display, by way of the viewing application and based at least in part on the received query result and a time window derived from the user input that limits the query result, a dependency tree that includes the target batch job and the one or more precedent batch jobs from the query result;
depicting, by way of the viewing application and based at least in part on the received query result, a critical path of the target batch job on the electronic display, wherein the critical path includes one or more critical jobs, the one or more critical jobs being a subset of the one or more precedent batch jobs that process data required by the target batch job;
optimizing, via one or more optimizations made by optimization tools provided by the viewing application, the execution order of the plurality of batch jobs such that a total execution runtime of the one or more critical jobs is decreased such that the target batch job finishes executing earlier than the target batch job would have finished executing without the one or more optimizations, the total execution runtime being the sum of the execution runtimes of the one or more critical jobs; and
sending, by way of the viewing application, instructions to the scheduling server to implement the one or more optimizations.

16. The computerized method according to claim 15 further comprising:
generating, by way of the viewing application, at least one of an expected execution start time and an expected execution runtime for at least one of the target batch job and the one or more precedent batch jobs;
wherein optimizing the execution order is based at least in part on one of the expected execution start time and the expected execution runtime.

17. The computerized method according to claim 16, further comprising:
generating, by way of the viewing application, a warning based at least in part on at least one of a scheduled execution start time, an execution start time, the execution runtime, a historical execution start time, a historical execution runtime, the expected execution start time, and the expected execution runtime of at least one of the target batch job and the one or more precedent batch jobs; and
issuing the warning to a user via at least one of the electronic display and an electronic mobile device.

18. The computerized method according to claim 15, wherein optimizing the execution order is automatically performed by the viewing application.

19. The computerized method according to claim 15, wherein the query result further comprises an indication of dependencies among the target batch job and the one or more precedent batch jobs.

20. The computerized method according to claim 15, wherein the query result further comprises an indication of a scheduled execution start time, an execution start time, and a status of each of the one or more precedent batch jobs and the target batch job;
wherein the status is at least one of running, waiting, completed, completed and in critical path, failed, terminated, scheduled, and on hold.
